(19) United States
(12) Patent Application Publication
(10) Pub. No.: US 2001/0022351 A1
(43) Pub. Date: Sep. 20, 2001

(54) Tap for compressed or liquefied gases

(76) Inventor: Paul Kremer, Walferdange (LU)

Correspondence Address: LEYDIG VOIT & MAYER, LTD, 6815 WEAVER ROAD, ROCKFORD, IL, 61114-8018, US

(21) Appl. No.: 09/767,551

(22) Filed: Jan. 23, 2001

(30) Foreign Application Priority Data
Jan. 24, 2000 (LU) 90 508

(51) Int. Cl. F16K 31/44

(52) U.S. Cl. 251/83

(57) ABSTRACT

The tap comprises a body (10) containing a closing member for opening or closing the passage of the gas between an inlet connection piece (12) and an outlet connection piece (14), and also a control valve (20) for controlling the flow of the gas between the inlet connection piece (12) and the outlet connection piece (14) and comprising a piston (28) sliding non-sealingly in a cylindrical receptacle (26) and carrying on one of its faces a closing seal (30) for closing the passage of the gas, and a spring (40) stressing said piston (28) axially in the closing direction of the passage. In order to prevent the valve from becoming resonant, the spring (40) is mounted in an axial cylindrical pocket (38) of the piston (28) and is compressed between the bottom of said pocket (38) and a cylindrical block (42) which is likewise engaged at least partially in said pocket (38), said cylindrical block comprising a seal (44) ensuring leak-tightness relative to the side wall of said pocket (38) during the sliding of the piston (28) relative to said block (42), said block (42) comprising an axial duct (46) closed by means of a filter (48).

### FIELD OF THE INVENTION

The present invention relates to a tap for compressed or liquefied gases, comprising a body containing a closing member for opening or closing the passage of the gas between an inlet connection piece and an outlet connection piece, and also a control valve for controlling the flow of the gas between the inlet connection piece and the outlet connection piece and comprising a piston sliding non-sealingly in a cylindrical receptacle and carrying on one of its faces a closing seal for closing the passage of the gas, and a spring stressing said piston axially in the closing direction of the passage.

### BACKGROUND OF THE INVENTION

A tap of this type is described in the document EP-A1-0 458 253. The control valve in this tap is a residual-pressure valve intended for preventing a complete emptying of the bottle or tank on which the tap is mounted. This is a well-known measure for preventing impurities or moisture from penetrating through a tap used, in particular, with gases for which a high degree of purity is demanded, such as, for example, those used for the doping of semiconductors.

The residual-pressure valve is subjected to the action of a calibrated spring which stresses the closing piston towards its closing position. However, during draw-off, the pressure of the gas is normally sufficient to drive the piston back counter to the force of its spring and keep the valve in the open position. Only when the tank begins to empty and the pressure of the gas falls below the calibration pressure of the spring does the latter close the valve counter to the pressure of the gas and prevent the gas from escaping.

It was found that these taps equipped with a residual-pressure valve emit noise during the draw-off of the gas and, more particularly, at a specific flow rate. This noise emission may be explained in the following way. When the draw-off flow rate is lower than the available flow rate coming from the gas tank, all of the gas cannot leave through the outlet of the tap. Under these circumstances, since the piston of the valve must necessarily be guided non-sealingly in its receptacle so as to be capable of sliding in the latter, the gas penetrates behind the piston. This accumulation of gas under pressure behind the piston causes the pressure of the gas on either side of the piston to be balanced. Consequently, the piston is subjected only to the force of its spring and closes under the action of the latter. However, as long as it is closed, continuing the draw-off through the outlet of the tap lowers the pressure of the gas behind the piston, with the result that the pressure of the gas coming from the tank once again becomes sufficient to lift the piston from its seat counter to the action of its spring. There is therefore, once more, a gas excess which raises the pressure behind the piston in order ultimately to close it again. This succession of openings and closings is repeated at a very fast rate and generates a kind of resonance of the valve which causes the noise. These vibrations are not only troublesome to the operator because of the noise, but also cause rapid wear, particularly of the seals.

This phenomenon was observed not only in taps with a residual-pressure valve, but also in taps equipped with a pressure reducer, that is to say a pressure-adjusting valve, as in the document EP-B1-0 496 091.

### SUMMARY OF THE INVENTION

The object of the present invention is to provide a tap of the type described in the introduction, in which the inopportune vibrations of the control valve and the disadvantages arising from them are eliminated or are at least reduced substantially.

To achieve this object, the invention provides a tap of the type described in the introduction, which is characterized in that said spring is mounted in an axial cylindrical pocket of the piston and is compressed between the bottom of said pocket and a cylindrical block which is likewise engaged at least partially in said pocket, said cylindrical block comprising a seal ensuring leak-tightness relative to the side wall of said pocket during the sliding of the piston relative to said block, and in that said block comprises an axial duct provided with means for braking the passage of the gas through this duct, these means possibly being a filter.

The filter may be made of metal which is sintered and is permeable to the gas, but which opposes some resistance to the latter when it passes through. On account of this resistance to the passage of the gases, the filter brakes the movement of the piston and increases the reaction time in response to the thrust of the pressure of the gases and of the spring. In fact, the filters perform the function of a damper which prevents the valve from becoming resonant and from emitting noise.

According to an advantageous embodiment, the valve takes the form of a removable compact cartridge comprising a cap which is capable of being screwed onto a connection piece of the tap and the interior of which defines the cylindrical receptacle of the opening and closing piston.

### BRIEF DESCRIPTION OF THE DRAWINGS

Other particular features may be gathered from the detailed description of an advantageous embodiment given below by way of illustration, with reference to the accompanying drawings in which:

FIG. 1 is a perspective view of a tap according to the present invention;

FIG. 2 is a horizontal section through the tap along a sectional plane passing through the axis of the outlet connection piece, and

FIG. 3 is a sectional view of the separate residual-pressure valve.

### DETAILED DESCRIPTION OF THE PREFERRED EMBODIMENTS

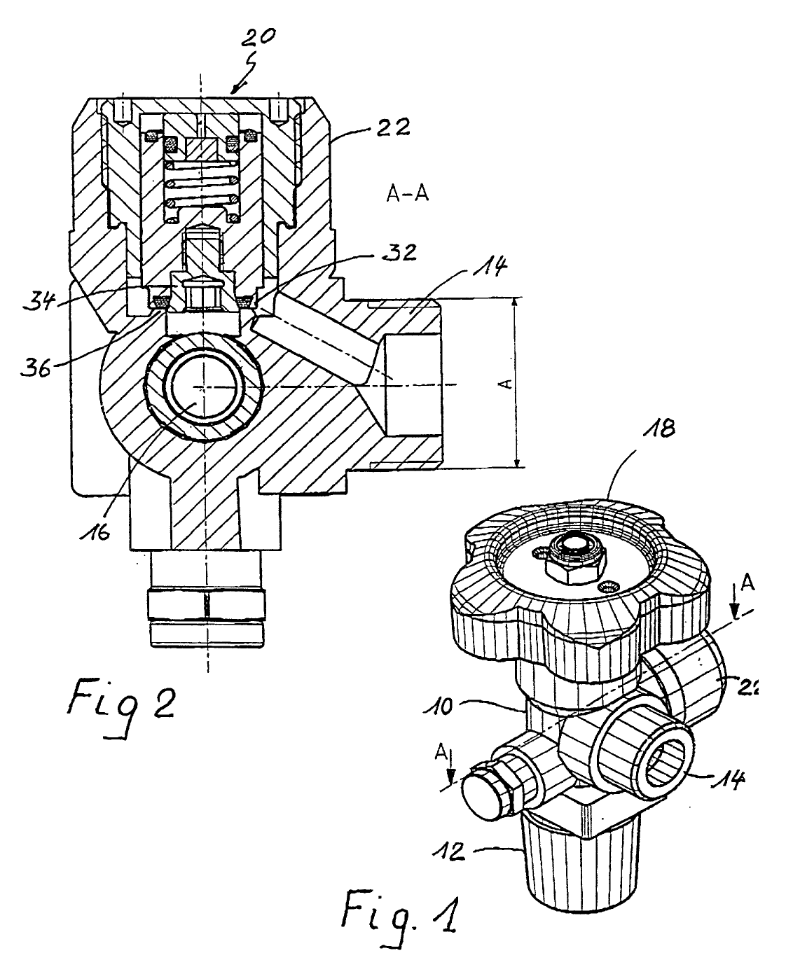

The tap shown in FIG. 1 comprises a body 10, for example made of brass, with an axial inlet connection piece 12 which is equipped with an external thread allowing the tap to be screwed onto a tank, for example a gas cylinder. The body 10 also comprises an outlet connection piece 14 which communicates with the inlet connection piece 12 via an intermediate passage 16. In this inner passage 16 is located the main closing member, not shown, of the tap, said member being actuated by means of an outer operating handwheel 18.

The tap comprises, furthermore, in the region of the outlet connection piece 14, another radial connection piece 22, in which is screwed a residual-pressure valve 20 which serves for cutting off the inner passage 16 when the pressure of the gas falls below a predetermined value. In FIG. 1, the valve 20 is in such a closing position, preventing the gas from passing through the passage 16 towards the outlet connection piece 14.

The valve 20 takes the form of a compact cartridge (see FIG. 3) comprising a cylindrical cap 24 capable of being screwed into the connection piece 22. The interior of the cap 24 forms a cylindrical receptacle 26 for a likewise cylindrical piston 28 capable of sliding axially in the receptacle 26. There is no leak-tightness between the piston 28 and the cap, with the result that the gases under pressure can penetrate along the wall of the piston 28 towards the bottom of the receptacle 26.

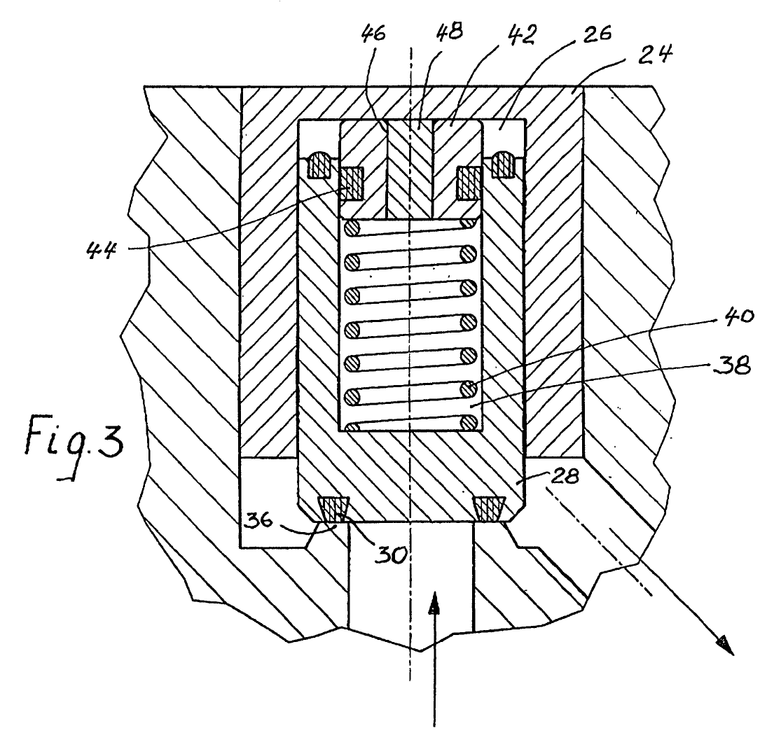

On the inner face of the piston 28 is located an annular seal 30 which can be held in place between a peripheral rim 32 and a central wedge 34 capable of being screwed into the head of the piston 32, as in FIG. 2, or which can simply be housed in a front groove, as in FIG. 3. The seal 30 cooperates with an annular seat 36 of the body of the tap, so as, in the closed position of FIG. 2, to interrupt the flow of gas from the passage 16 towards the outlet connection piece 14.

On the opposite face to the seal 30, the piston 28 possesses a cylindrical axial pocket 38, in which is located a helical spring 40 which is compressed between the bottom of the pocket 38 and a cylindrical block likewise located partially or completely in the pocket, depending on the position of the valve, and bearing on the bottom of the cap 24. The block 42 carries, on its periphery, a seal, for example an O-ring seal 44, which ensures leak-tightness relative to the side wall of the pocket 38. This configuration consequently allows the piston 28 to slide axially relative to the cap 24 and relative to the block 42 under the action of the spring 40 or of the pressure of the gases.

However, to allow this sliding of the piston 28, which is necessarily accompanied by a variation in the volume of the pocket 38, the latter must be in communication with the bottom of the receptacle 26 because of the leak-tightness ensured by the seal 44, in order to be capable of expelling the gases from the pocket during the opening (reduction in the volume of the pocket 38) of the valve and of aspirating the gases during the closing of the valve (increase in the volume of the pocket 38).

For this purpose, the block 42 comprises an axial duct 46 which is open onto the bottom of the receptacle 26. A filter 48, which may be a pellet of sintered metal, is located in this duct 46 and is wedged in the block 42. The filter may extend over the entire length of the duct or over a particular distance, as in FIG. 1. This metal may have the gas passing through it, but opposes some resistance to this gas, so as to slow the axial movement of the piston 28 during the opening and closing of the valve and to perform as it were the function of a pneumatic damper. It was found that, by sufficiently braking the movement of the piston in this way, it is possible to reduce the resonant vibrations of the piston appreciably and even eliminate them completely.

The filter 48 is only one example of the braking of the passage of the gases and may be replaced by equivalent means, such as a very fine contraction.

What is claimed is:

1. Tap for compressed or liquefied gases, comprising a body (10) containing a closing member for opening or closing the passage of the gas between an inlet connection piece (12) and an outlet connection piece (14), and also a control valve (20) for controlling the flow of the gas between the inlet connection piece (12) and the outlet connection piece (14) and comprising a piston (28) sliding non-sealingly in a cylindrical receptacle (26) and carrying on one of its faces a closing seal (30) for closing the passage of the gas, and a spring (40) stressing said piston (28) axially in the closing direction of the passage, characterized in that said spring (40) is mounted in an axial cylindrical pocket (38) of the piston (28) and is compressed between the bottom of said pocket (38) and a cylindrical block (42) which is likewise engaged at least partially in said pocket (38), said cylindrical block comprising a seal (44) ensuring leak-tightness relative to the side wall of said pocket (38) during the sliding of the piston (28) relative to said block (42), and in that said block (42) comprises an axial duct (46) provided with means for braking the passage of the gas through this duct (46).

2. Tap according to claim 1, characterized in that said means consist of a filter (48).

3. Tap according to claim 2, characterized in that the filter (48) is made of metal which is sintered and is permeable to the gas, but opposes some resistance to the passage of the gas.

4. Tap according to claim 1, characterized in that the valve (20) takes the form of a removable compact cartridge comprising a cap (24) which is capable of being screwed onto a connection piece (22) of the tap and the interior of which defines the cylindrical receptacle (26) of the opening and closing piston (28).
